(19) United States
(12) Patent Application Publication
(10) Pub. No.: US 2010/0124592 A1
(43) Pub. Date: May 20, 2010

(54) SYSTEM AND METHOD FOR FOOD PRODUCTS

(76) Inventor: JOHN D. ANDERSON, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/466,374

(22) Filed: May 14, 2009

Related U.S. Application Data
(63) Continuation-in-part of application No. 12/041,551, filed on Mar. 3, 2008.
(60) Provisional application No. 61/127,836, filed on May 14, 2008.
(60) Provisional application No. 61/127,831, filed on May 14, 2008.
(60) Provisional application No. 61/127,829, filed on May 14, 2008.

(51) Int. Cl. A23L 1/27

(52) U.S. Cl. 426/270

(57) ABSTRACT

A food development method to enrich a target food product recipe by the addition of ingredients made into dehydrated vegetable powders that when incorporated into a target food recipe replicates the taste, color, and texture of the target food product. The dehydrated vegetable powders are designed to minimize impact on color, taste, and texture when added to a target food product recipe.

### PRIORITY CLAIM

This application claims priority to U.S. Provisional Patent Application Ser. Nos. 61/127,836; 61/127,832; 61/127,831 and 61/127,829, all filed May 14, 2008. This application is also a Continuation-in-Part of U.S. patent application Ser. No. 12/041,551 filed Mar. 3, 2008. All of the foregoing applications are hereby incorporated by reference in their entirety.

### FIELD OF THE INVENTION

This invention relates generally to a method for deriving a recipe a favorite food product having known nutritional content based upon the presence of whole food nutrients, and more specifically for masking the bitterness of the whole food nutrients by a freezing method.

### BACKGROUND OF THE INVENTION

Convenience food, or tertiary processed food, is commercially prepared food designed for ease of consumption. Products designated as convenience foods are often pre-prepared food stuffs that can be sold as hot, ready-to-eat dishes, as room temperature, shelf-stable products, or as refrigerated or frozen products that require minimal preparation, typically just heating, by the consumer.

Convenience foods often are sold in portion controlled, single serve packaging designed for portability for “on-the-go” or later eating. Critics have derided the increasing trend of convenience foods because of numerous issues. Diet-responsive conditions such as obesity, hypertension, hyperlipidemia, cancer, diabetes, and combinations thereof are readily caused or exacerbated by consumption of convenience foods.

To alleviate the concerns that many consumers have regarding consumption of convenience foods, producers of convenience foods have used methods of nutritional enhancement to increase the apparent food value of those convenience foods. Generally, the methods of nutritional enhancement involve fortification of meal components of the prepackaged meals by addition of chemical nutrients such as dietary minerals or vitamins. Regulations by the United States Department of Agriculture (USDA) require the display of nutritional information in a tabular form. For example, on any given food product, in rows of a table printed on the packaging, nutritional value of the product is shown. In a popular Macaroni and Cheese formulation, the content of Vitamin A is shown as a percentage of the USDA recommended daily allowance (RDA) of Vitamin A as would be present in a uniform single serving as set forth in a row therein. Vitamin C, dietary calcium, and dietary iron are likewise portrayed. The degree of fortification is determined by a variety of factors, including the methods of processing, packaging, storing, and preparing the meals, the duration of storage, and the amounts of these elements desired for effective management of the diet-responsive condition.

The addition of chemical nutrients, however, has proven to be largely inadequate to meet all of the issues relating to health. For example, a growing area of interest is the effect upon human health of the presence of trace chemicals, collectively called phytochemicals. These antioxidant nutrients are typically found in edible plants, especially colorful fruits and vegetables, but also other organisms including seafood, algae, and fungi. One of the principal classes of phytochemicals is polyphenol antioxidants, chemicals which are known to provide certain health benefits to the cardiovascular system and immune system. Additionally, phytochemicals are known to down-regulate the formation of reactive oxygen species, key chemicals in cardiovascular disease. Also, whole foods such as colorful fruit and vegetable matter, as opposed to chemical nutrients, has been found desirable in order to preserve the presence of nutrients, known and unknown, in whole foods.

Addition of whole foods into convenience foods has proven extremely difficult because such convenience foods have attributes, such as flavor, texture, and color that account for their popularity. Whole foods tend, however, to have very distinctive characteristics that generally change those attributes of the food into which they are introduced. Simple mixture of whole foods into convenience foods simply changes the convenience food in a manner that makes the convenience food, as mixed, to be unpalatable.

For example, research has shown that 80% of children are genetically pre-wired to dislike bitter tastes. This is probably because most poisons and toxins in nature are bitter. Over time, we have evolved to dislike these tastes. In general, there are real chemical and biological reasons why kids don't like vegetables. They simply don't taste good.

### BRIEF DESCRIPTION OF THE DRAWINGS

FIG. 1 is a depiction of a spill-proof drink closure.

### DETAILED DESCRIPTION OF THE PREFERRED EMBODIMENT

A method to incorporate whole food additives into convenience foods to improve the nutritional makeup is disclosed herein. A method of incorporation of natural ingredients into a target food product recipe is configured to modify a nutritional makeup of the target food product without significantly changing the target food's sensory attributes is further disclosed herein. The method includes selective incorporation of at least one dehydrated vegetable powder having known nutritional attributes in measured quantities modifies nutritional makeup without significant modification of the sensory attributes of the resulting food product.

In one, nonlimiting embodiment, a dehydrated vegetable powder is incorporated into the target food product in order to enhance the nutritional attributes of the target food product. The at least one dehydrated vegetable powder is selected from, for example, yellow-based dehydrated vegetable powders made from vegetables such as yellow potatoes, sweet potatoes, yellow winter squash, yellow corn, yellow beets, or rutabaga, amongst others. Other exemplary vegetable dehydrated vegetable powders are made in a spectrum range of colors including green, orange, red, purple, blue and white. Combinations of colored dehydrated vegetable powders can be combined to achieve alternative variations in color. For example, it may be desirable to combine a yellow-based dehydrated vegetable powder and red-based dehydrated vegetable powders to achieve a dehydrated vegetable powder which is orange colored having a whole food vitamin C content. Examples of colored dehydrated vegetable powders include, for orange-colors: dehydrated vegetable powders made with pumpkin, carrots, yams, and orange beets, amongst others, or alternately, by combining yellow-based dehydrated vegetable powders and red-based dehydrated vegetable powders. Red-based dehydrated vegetable powders have red beets, red pepper, red beans, and tomatoes, contributing colors from whole foods. To achieve purple, a dehydrated vegetable powder including purple cauliflower, purple carrots, and purple potatoes, is a first example; while combining red-based dehydrated vegetable powders and blue-based dehydrated vegetable powders is a second example. Blue-based dehydrated vegetable powders include blue potatoes, blue kale, and blue corn, amongst others. Green based dehydrated vegetable powders include kale, chard, spinach, peas, green pepper, lima beans, soy beans, and black beans, amongst others, where special consideration is taken for the bitter taste of leafy green vegetables. White-based dehydrated vegetable powders include cauliflower, white corn, white beans, black eyed peas, parsnips, parsnip, turnip, and taro, amongst others. While alternate embodiments exist for achieving a single colored dehydrated vegetable powder, selection of a dehydrated vegetable powder is also based upon nutritional attributes of the dehydrated vegetable powder and the desired nutritional attributes in the target food.

In one exemplary embodiment a macaroni and cheese dinner can be made that closely resembles a child favorite target recipe, Kraft® Macaroni & Cheese Dinner. The product has a texture where any noticeable pieces of vegetables would be detected by the naked eye, so the dehydrated vegetables materials reduced to a powder with a high water solubility disguise the addition of the vegetable matter. The product has a yellow/orange hue so natural ingredients with neutral or similar color profiles were chosen to match the sensory profile of the target food product. In this example and as was discussed above, the following enrichment dehydrated vegetable powders can be used, but are not limited to: sweet potato powder, carrot powder and/or carrot juice powder, white potato powder, Carrot fiber, tomato juice powder, and/or citrus powder. In use, the mix of dehydrated vegetable powder is then combined with a packaged cheese powder in the ratio of approximately 1 to 4, but not to substantially exceed 25% by weight of added cheese so as to preserve the sensory characteristics of the favorite target food product.

By way of example, the finished product is a box containing a package of dry pasta and a package of enriched cheese sauce. The customer is instructed to cook the pasta in boiling water, and then add the cheese sauce, some butter (optional), and milk. The result is a product with very similar flavor, color, and texture to the conventional product with significant nutritional boost from the vegetable material.

In another exemplary embodiment a favorite puffed rice treat can be made. The embodiment of the invention closely mimics the childhood favorite target food Kellogg's® “Rice Krispie Treats” in flavor, color, and texture. The subject of the instant invention is made with the addition of dehydrated vegetable powder, thus enriching the nutritional content, but without changing the sensory profile of the favorite food.

The target product in this exemplary embodiment has a white/light yellow/light brown hue so natural ingredients used to make the dehydrated vegetable powder have a similar color profile. In this example and as was discussed above, the following enrichment dehydrated vegetable powders can be used, but are not limited to: cauliflower powder (freeze dried & powdered), citrus powder, potato powder (freeze dried & powdered), corn powder (instant corn meal), brown rice solids, yellow sweet potato powder (freezer dried, powdered).

In a preferred embodiment the maximum amount of dehydrated vegetable powder added was less than or equal 25%. The point at which nutrition was maximized and dehydrated vegetable powder was also maximized was at 20%. However any amount of dehydrated powder may be used.

In one embodiment, the method for making the product involves mixing of the vegetable material with the puffed rice. This mix can then be combined with a shelf-life extender, which can include but is not limited to a binding mix that includes brown rice syrup solids, and/or glycerin. The bar is then manufactured and packaged for marketing. Three varieties of the bar are contemplated, but not limited by this disclosure, a basic bar, a bar with chocolate chips, and bar with peanut butter and chocolate chips.

While the preferred embodiment of the invention has been illustrated and described, as noted above, many changes can be made without departing from the spirit and scope of the invention. In this case, the choice of the macaroni and cheese recipe and the puffed-rice treat as representative target food products, and the development of a nutritionally enriched recipe for macaroni and cheese and puffed rice treat are exemplary. The food development method detailed here will understandably vary according to the selected target food product under development, the representative recipes selected, the sensory attributes measured, the desirable sensory attributes for the given target food, the selected nutritional attributes sought to be enriched in the target food product, and the ingredients incorporated into the dehydrated vegetable powders to nutritionally enrich the target food product recipe. Accordingly, the scope of the invention is not limited by the disclosure of the preferred embodiment.

A method to incorporate whole food additives into convenience foods to improve the nutritional makeup, while suppressing the bitter flavor of the added nutritional content is disclosed herein. A method of incorporation of natural ingredients into a target food product recipe is configured to modify a nutritional makeup of the target food product. Selective incorporation of at least one puree having known sensory and nutritional attributes in measured quantities modifies the nutritional makeup. Subsequent freezing of a prepared dish using nitrogen or ammonia freezing technology is then preformed.

In one, non-limiting embodiment, at least one puree of vegetables is incorporated into the target food product in order to enhance the nutritional attributes of the target food product. The at least one puree is selected from, for example, yellow-based purees made from vegetables such as yellow potatoes, sweet potatoes, yellow winter squash, yellow corn, yellow beets, or rutabaga, amongst others. Other exemplary vegetable purees are made in a spectrum range of colors including green, orange, red, purple, blue and white. Combinations of colored purees can be combined to achieve alternative variations in color. For example, it may be desirable to combine a yellow-based puree and red-based purees to achieve a puree which is orange colored having a whole food vitamin C content. Examples of colored purees include, for orange-colors: purees made with pumpkin, carrots, yams, and orange beets, amongst others, or alternately, by combining yellow-based purees and red-based purees. Red-based purees have red beets, red pepper, red beans, and tomatoes, contributing colors from whole foods. To achieve purple, a puree including purple cauliflower, purple carrots, and purple potatoes, is a first example; while combining red-based purees and blue-based purees is a second example. Blue-based purees include blue potatoes, blue kale, and blue corn, amongst others. Green based purees include kale, chard, spinach, peas, green pepper, lima beans, soy beans, and black beans, amongst others, where special consideration is taken for the bitter taste of leafy green vegetables. White-based purees include cauliflower, white corn, white beans, black eyed peas, parsnips, parsnip, turnip, and taro, amongst others. While alternate embodiments exist for achieving a single colored puree, selection of a puree is also based upon nutritional attributes of the puree and the desired nutritional attributes in the target food.

Both the composition and process of producing a vegetable-enriched food product as herein describe has several advantages over the related art. The invention uses a unique blend of cooked and pureed vegetable material which contributes a significant level of soluble fiber and vitamins without adversely impacting texture, mouth feel, color or flavor. Additionally, the freezing of the product as described in the present invention is designed to reduce the bitter taste and smell of the vegetables in the resulting product. The process as detailed therefore delivers a food product with a smooth texture and pleasant flavor with no grittiness or off flavors.

These and other examples of the invention will be described in further detail below.

In one embodiment, the present invention comprises a system for providing healthy and convenient foods that maintain desirable sensory attributes. Target food recipes are enriched with the addition of healthy, nutritional ingredients made into purees, that when added to a target food recipe replicates the taste, color, and texture of the target food product. The food product can then be subjected to a rapid freezing technique, for example, but not limited to nitrogen or ammonia freezing, is to minimize the impact on taste, specifically the characteristic bitter taste of some vegetable and/or nutritional ingredients.

In accordance with some examples of the invention, the present invention is a vegetable-enriched frozen food product and a process for manufacturing the food product. The vegetable-enriched frozen food product can contain a variety of vegetables hidden within the food product. The pureed vegetable ingredients in combination with the unique system of freezing during manufacture are combined to produce a highly nutritional food product that has at least one enhanced nutritional attribute, for example the following enhanced nutritional features can be enhanced: a significant level of fiber, a reduced fat content, and increased vitamin content; while also maintaining the sensory attributes of a good flavor, a satisfactory mouth feel, and a smooth texture.

In one embodiment manufacturing vegetable-enriched food products involves, but is not limited to, primary steps carried out in sequence comprising the steps of: 1. Assembly of the frozen entree and fill container; and 2. rapid freezing of the entree using nitrogen or ammonia freezing technology. If a product enriched with vegetables is tasted prior to freezing, the presence of vegetables can be detected by most adults. If the product is instead frozen and held for a period of 1 week, the presence of vegetables cannot be detected.

In another embodiment, the nutritionally enriched food product is subjected to multiple rounds of freeze-thaw cycles, preferably, but not limited to two freeze-thaw cycles, wherein, the flavor of the vegetables after taste sampling is not detectable.

In one exemplary embodiment, the present invention relates to a frozen macaroni and cheese entree comprising: 1) a pureed blend of vegetable material having the same color as the target food product (e.g., the cheese sauce is yellow), for up to a maximum amount of 50% of the formula by weight: 2) a cheese sauce; and 3) a pasta.

In another embodiment, the invention also relates to a process of manufacturing a frozen vegetable-enriched macaroni and cheese product whereby a nutritional blend of at least one vegetable, that can be for example a puree and/or a vegetable chopped into a very fine particle size, is added into the cheese sauce. The vegetable nutrient is added such that the addition does not significantly alter the color, or texture of the cheese sauce. The method further involves the subsequent freezing of the frozen vegetable-enriched macaroni and cheese product to reduce the bitter taste and smell of the vegetables. This process of manufacture delivers full flavor impact and smooth texture without an adverse effect on mouth feel or color.

In another embodiment, the invention includes a method of making a frozen vegetable-enriched food product without introducing traditional starches or thickeners. In this method, thickening is achieved by using a unique blend of cooked and pureed vegetables.

In another embodiment, the invention includes a method of making a frozen vegetable-enriched food product without introducing a coloring agent. In this method, the desired color is achieved by using a unique blend of cooked and pureed vegetables with the same color profile as the target food product, for example the cheese sauce in the Macaroni and Cheese embodiment.

SID—sensory integration dysfunction is a diagnosis that comes from neurologists. Many children with autism have SID. The common symptoms are food sensitivities based on the sight, taste, smell, and touch senses. It is a neurological issue, just like autism. It is common for kids with autism to also have SID. But not all kids with SID have autism.

The reality is most kids have some food sensory issue with veggies or some other food. It is a spectrum disorder, and its degree ranges.

And some kids “grow out of it”, which is really just an increase in the sensory diet as they mature. Spectrum example: Some kids won't eat any veggies, some will eat carrots but not broccoli. Some won't eat mayonnaise because of its texture. You've seen them turn their noses up at the smell of beef cooking. Or you see the kid that only eats Chicken McNuggets® and macaroni and cheese.

How our products help? We give parents of kids who have sensory issues with veggies (whether it is sight, taste, smell, or touch) a meal solution. We take a kid favorite and add the veggies without changing the taste profile of the kid favorite. The kid gets the nutritional value without having to “stomach” something to which he/she has a sensory aversion.

Sensory integration is the neurological process of organizing the information we get from our bodies and from the world around us for use in daily life. Sensory integration dysfunction is the inability to process information received through the senses. This means that just about everyone on the autism spectrum that I have met has a large variance from what might be considered as typical in how they sense and perceive the world. Some of the senses may be turned up “too high,” others are “too low,” and a substantial amount of data received through the senses may be distorted.

Sensory Variations/The Outer Senses. Most people are aware of the five senses of sight, hearing, taste, smell, and touch. One theory is that people on the autism spectrum are born with too many, yet immature, nerve endings. This theory gives an explanation as to why most people with autism experience problems with sensory integration. Some or all of the five senses may be hyper-sensitive whereas others may be hypo-sensitive. The data received from these senses may also be distorted.

The Inner Senses. The vestibular and proprioceptive senses are often referred to as the hidden or inner senses. The vestibular sense helps with movement, posture, vision, balance, and coordination of both sides of the body.

Proprioception informs a person as to where his body parts are in space and the appropriate amount of force needed to perform an activity such as picking up a glass of milk. Hyper and hypo sensitivities as well as distortions with these two inner senses cause challenges for those on the autism spectrum.

Sensory Integration Dysfunction is the inability of the brain to correctly process information brought in by the senses. Sensory Integration Dysfunction (SID/DSI) or sensory processing deficits can come in many different forms. No two children will be affected in the same ways. SIDIDSI was first noticed in children with autism or who had autistic traits but is also seen in children with other disabilities such as cerebral palsy or ADD/ADHD or can be present by itself. Children can have mild, moderate or severe SI deficits.

Below is a list of other behaviors exhibited by children with SIDIDSI:
Loves to spin, swing and jump—this will seem to calm them down after several minutes.
Complains of how clothing feels, does not like tags left in their clothing and have to have their socks on just so, or a certain kind of sock.
Picky eaters get stuck on one certain food and is basically impossible to get them to eat anything else.
Oversensitivity to smells. Or undersensitivity—may sniff people, objects, food.
Oversensitivity to sounds—will frequently cover ears. Or undersensitivity.
May have an exceptionally high pain tolerance
May tire easily
Unusually high or low activity level
Resists new situations
Problems with muscle tone, coordination, motor planning
Can be very impulsive or distractible.
Persistently walks on toes to avoid sensory input from the bottom of the feet. This can also be a sign of cerebral palsy if the child is unable to bring their feet down flat when asked or trying.

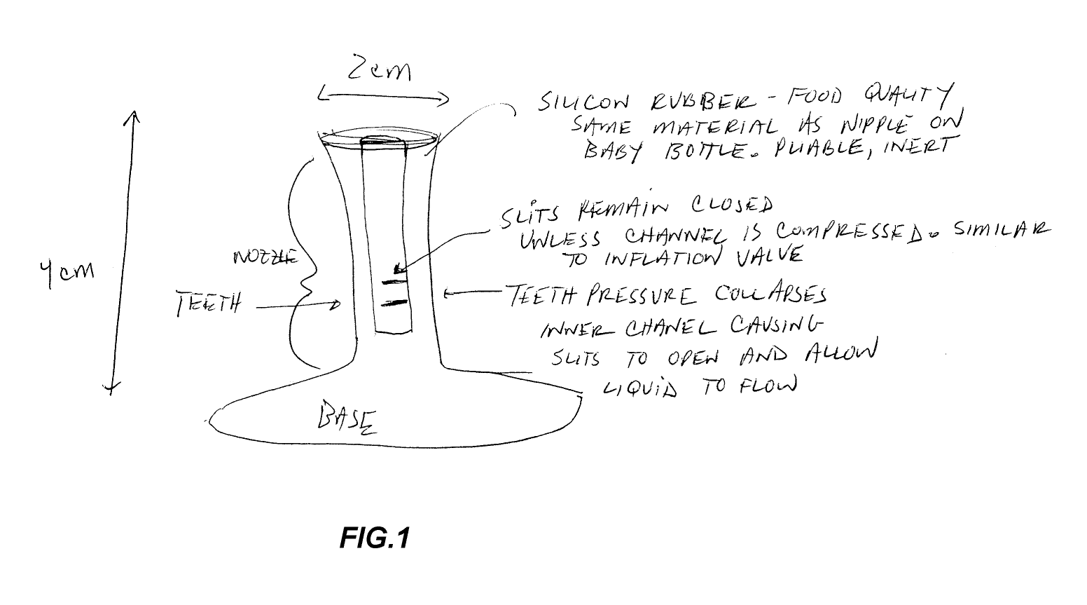

FIG. 1 depicts a spill-proof drink closure. The problem with children's drink products is that they spill. In one embodiment, the drink closure is comprised of silicon rubber, food quality, same material as the nipple on a baby bottle, pliable and inert.

As shown in FIG. 1, the slits remain closed unless the channel is compressed similar to an inflation valve. As also illustrated in FIG. 1, the teeth pressure collapses the inner channel, causing slits to open and allow liquid to flow. The closure can be attached to a screw top bottle or to a pouch. The drink closure in FIG. 1 further illustrates that liquid will only flow when the child bites on the nozzle and applies sucking pressure.

While the preferred embodiment of the invention has been illustrated and described, as noted above, many changes can be made without departing from the spirit and scope of the invention. In this case, the choice of the macaroni and cheese recipe as a representative target food product, and the development of a nutritionally enriched recipe for macaroni and cheese are exemplary. The food development method detailed here will understandably vary according to the selected target food product under development, the representative recipes selected, the sensory attributes measured, the desirable sensory attributes for the given target food, the selected nutritional attributes sought to be enriched in the target food product, and the ingredients incorporated into the puree to nutritionally enrich the target food product recipe. Additionally, varying numbers of freeze-thaw cycles may be employed, and different freezing technologies may be used without departing from the spirit of the invention. Accordingly, the scope of the invention is not limited by the disclosure of the preferred embodiment.

The embodiments of the invention in which an exclusive property or privilege is claimed are defined as follows:

1. A method for enhancing a nutritional value of a target food product without significantly changing an established sensory profile of the target food product comprising the steps of:
selecting a target food according to a moisture content of a principal component;
preparing a base recipe based upon the target food;
observing a color of the principal component to determine a component color;
selecting a puree for addition to the base recipe according to the component color; and
incorporating an incremental amount of the puree into the base recipe to form an interim recipe.

2. The method of claim 1 wherein the puree of ingredients includes vegetables selected according to the component color.

3. The method of claim 2, wherein selecting the puree further includes selecting the puree from a spectrum of purees arranged by color.

4. The method of claim 1 wherein the puree of ingredients selected includes whole grains.

5. The method of claim 1 wherein the puree of ingredients includes proteins.

6. The method of claim 1 further comprising:
comparing the interim recipe to the target food according to at least one of color, texture, acidity, and sweetness.

7. A system for augmenting a basic recipe to produce a target food, the system comprising:
a basic recipe selected based upon the target food; and
at least one puree for incorporation into the basic recipe to produce an interim food, the puree being selected from a group consisting of red puree, blue puree, green puree, white puree, yellow puree, purple puree, orange puree and combinations thereof.

8. The system of claim 7, wherein the red puree includes:
at least one ingredient selected from a red collection of ingredients consisting of red beets, red pepper, red beans, tomatoes and combinations thereof.

9. The system of claim 7, wherein the yellow puree includes:
at least one ingredient selected from a yellow collection of ingredients consisting of yellow potatoes, sweet potatoes, yellow winter squash, yellow corn, yellow beets, rutabaga and combinations thereof.

10. The system of claim 7, wherein the orange puree includes:
at least one ingredient selected from an orange collection of ingredients consisting of pumpkin, carrots, yams, orange beets and combinations thereof.

11. The system of claim 7, wherein the purple puree includes:
at least one ingredient selected from a purple collection of ingredients including purple cauliflower, purple carrots, purple potatoes and combinations thereof.

12. The system of claim 7, wherein the green puree includes:
at least one ingredient selected from a green collection of ingredients including kale, chard, spinach, peas, green pepper, lima beans, soy beans, black beans and combinations thereof.

13. The system of claim 7, wherein the white puree includes:
at least one ingredient selected from a white collection of ingredients including white corn, white beans, black eyed peas, parsnips, parsnip, turnip, taro and combinations thereof.

14. The system of claim 7, wherein the at least one puree for incorporation is selected based upon a color of the target food.

15. The system of claim 14, wherein the at least one puree is a combination of at least two purees blended to match the color of the target food.

16. A method for enhancing a nutritional value of a target food product without significantly changing an established sensory profile of the target food product comprising the steps of:
selecting a base recipe according to the target food;
selecting at least one member of a set of representative samples according to the target food;
measuring at least one sensory attribute to determine a value for each member of the set of representative samples;
establishing an upper and a lower threshold value for the at least one sensory attribute based upon the measured value of the at least one sensory attribute as present in the representative sample; and
incorporating a puree having a known values for the at least one sensory attribute and the at least one nutritional attribute into the product to alter the base recipe to a value within the a range between the upper and lower threshold values for the at least one sensory attribute.

17. The method of claim 16 wherein the at least one sensory attribute includes attributes selected from the attribute group, acidity (pH), sweetness (BRIX) color, and texture.

18. The method of claim 17 wherein the at least one sensory attribute includes color as measured by at least one color characteristic selected from a group consisting of hue, brightness, and saturation.

19. The method of claim 16 wherein the at least one texture characteristic is selected from a group consisting of Baume, density, viscosity, and particle size, wherein the new recipe must fall within a range of tolerance for at least one texture characteristic.
